(19) United States
(12) Patent Application Publication
(10) Pub. No.: US 2016/0052299 A1
(43) Pub. Date: Feb. 25, 2016

(54) SYSTEM FOR INK-JET PRINTING WITH DRYING

(71) Applicant: Jesús Francisco BARBERAN LATORRE, (US)

(72) Inventor: Jesus Francisco BARBERAN LATORRE, Castelldefels (Barcelona) (ES)

(21) Appl. No.: 14/784,498

(22) PCT Filed: Apr. 3, 2014
(86) PCT No.: PCT/ES2014/070264

§ 371 Date: Oct. 14, 2015

(30) Foreign Application Priority Data
Apr. 16, 2013 (ES) P201330544

(51) Int. Cl. B41J 11/00; B41J 2/21

(52) U.S. Cl. CPC B41J 11/002; B41J 2/21

(57) ABSTRACT

The present invention relates to a system for ink-jet printing with drying, comprising a plurality of ink-injection heads (1) by means of which the basic color inks are projected in order to form the prints, an individual ultraviolet UV-light drying means (5) with LED technology being arranged in relation to each ink-injection head (1), all the drying means (5) being located at an equal distance in relation to each other and the respective ink-injection head (1).

### FIELD OF THE ART

The present invention relates to digital ink-jet printing, proposing a system for applying such printing with individual drying of the each ink application, such that the effects of inks running on non-absorbent or slightly absorbent substrates are eliminated, thereby achieving high-quality results in the prints.

### STATE OF THE ART

Ink-jet printing is done by means of the individual projection of four basic color inks (cyan, magenta, yellow and black), the combinations of which lead to all the necessary colors, ink-injection heads being used for that purpose, which project the inks onto the surface to be printed by means of piezoelectric systems or by means of mechanical systems for droplet ejection.

In that regard there are systems for scan printing in which the ink-injection heads shift transversely from side to side of the surface to be printed, in combination with a forward movement of said surface in the longitudinal direction, thereby covering the printing area by means of successive back and forth passes.

These systems for scan printing can have a drying means drying the deposited ink in each printing pass, such that the amount of ink that can be deposited in each pass is limited according to the drying, so depending on the nature of the surface to be printed and particularly on the absorption thereof, better or worse quality prints can be made by means of one or a plurality of passes over the same point. However, even though the ink discharge capacity of the injection heads is in the order of 150 ml/min, the ink discharge limit in successive layers also depends on the conditions of the ink on which a subsequent layer of ink will be applied because the ink flows over a previous layer of ink that is completely dry, distorting the print.

There are also systems for continuous printing which uses an array of injection heads the assembly of which covers the width of the printing surface, such that it allows making prints by means of a single pass in the longitudinal direction, with shifting of the printing surface and the injection heads remaining still, with shifting of the injection heads and the printing surface remaining still, or with a combined shifting movement of the printing surface and the injection heads.

In these systems for continuous printing, the amount of ink that can be discharged is very limited because the printing ink is discharged only once, without the possibility to wait for the ink to be absorbed by the printing surface in order to make subsequent passes over it. The possibility of being able to deposit overlapping layers of ink with such printing is based on multiplying the number of injection heads in consecutive groups, applying drying between the deposition of each layer and the next one, like scan printing, but this possibility has such a high economic constraint that it is virtually unviable.

To improve the performance of continuous ink-jet printing, systems have been developed that use intermediate drying between the injection of the different colors, forcing the ink of each color to dry before applying the ink of the next color, whereby increasing by virtually four fold the ink acceptance capacity of the printing surface. In these systems, the ink dries to a point where the applied ink is in perfect conditions for depositing another ink on it.

However, in systems with heads arranged in a staggered manner to cover the width of the printing surface, which is a standard arrangement in continuous printing, there is an overlap problem that arises when inks of the same color applied by two consecutive heads working in parallel are partially mixed before drying, giving rise to a change in tone of the color affecting the area in which the inks are mixed due to the amount of pigment that builds up in said area.

Therefore, it is necessary to partially dry the ink not only between the different colors, but also between injector heads injecting the same color consecutively, so that the mixing of consecutive inks is mitigated by the fact that the ink first applied is partially dry before being overlapped by the ink that is applied later because the partially dry ink, which is in a gel state, acts as a barrier to prevent the next ink from spreading over it when it is applied.

### OBJECT OF THE INVENTION

The present invention proposes a system for ink-jet printing, whereby achieving an advantageous effect with respect to color stability because the inks that are applied are partially dried after each ink application, the ink being applied and dried in virtually a single step.

This system for printing object of the invention has an individual drying means in relation to each ink-injection head, the drying means being located next to the respective ink-injection heads, with an equal distance between each of the drying means and the corresponding ink-injection heads; using drying means the action of which when acting on the inks only causes partial drying thereof, leaving them in a gelled state.

A system for printing is thereby obtained with which color differences resulting on surfaces that have a different ink absorption capacity are significantly reduced because the inks that are applied are partially dried virtually at the time they are applied.

This also achieves greater color stability because the droplet sizes of all the inks are the same, due to the fact that since the inks dry virtually at the time they are applied, the ink droplets are prevented from expanding as they are absorbed by the print receiving surface.

Since the inks partially dry at the time they are applied and the ink droplet sizes applied by all the heads are the same, an improvement in the color combination quality is also obtained and a range of surfaces can be printed on regardless of the surface tension thereof because the ink droplets are immobilized and do not scatter.

In addition, since the inks partially dry between successive injections, the effect of rejection that some inks have when printed over a layer of the same ink that is completely dry and causes the ink printed thereon to end up with a rough appearance and an incorrect dot gain, causing a loss of control over the desired color, is prevented.

This system with partial drying of each ink virtually at the time it is applied furthermore allows printing at low speeds of up to 15 meters per minute, obtaining optimal quality, which is very useful because in many applications in which the printing process is in line with other slower processes (sanding, finishing, etc.), it allows not having to introduce acceleration/deceleration tables in the line, making it shorter and saving physical space.

The proposed system for printing therefore has very advantageous features due to the quality and sharpness of the prints it allows obtaining, acquiring its own identity and preferred character with respect to the conventional systems for printing having the same application.

### DESCRIPTION OF THE DRAWINGS

FIG. 1 shows a diagram of conventional ink-jet printing by means of scanning.

FIG. 2 is a diagram of conventional continuous ink-jet printing, without drying means.

FIG. 3 is a diagram of conventional continuous ink-jet printing, with drying between the application of the different colors.

FIG. 4 is a diagram of printing according to the system object of the invention.

FIG. 5 is a diagram of the result of two consecutive ink applications, with the first ink completely drying before applying the second ink.

FIG. 6 is a diagram of the result of two consecutive ink applications, with the first ink being partially dry when the second ink is applied.

FIG. 7 shows a diagram of the arrangement of two ink-injection heads with a common drying means and the result of the ink droplet size after drying.

FIG. 8 shows a diagram of the arrangement of two ink-injection heads with respective individual drying means and the result of the ink droplet size after drying.

FIG. 9 shows a graph of the expansion in microns of an ink droplet according to the time in seconds that elapses between the ink droplet falling during application and the partial drying thereof.

### DETAILED DESCRIPTION OF THE INVENTION

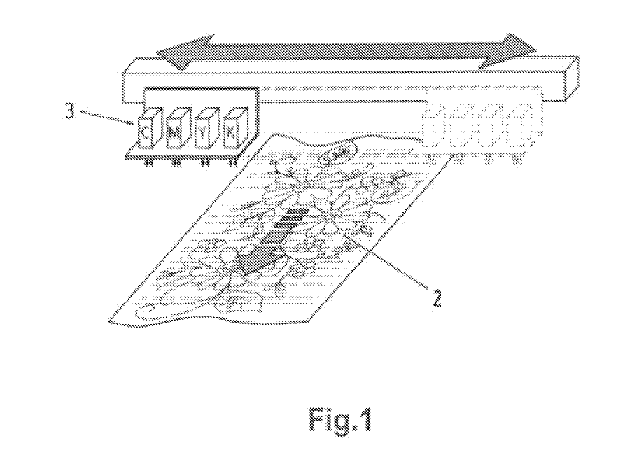

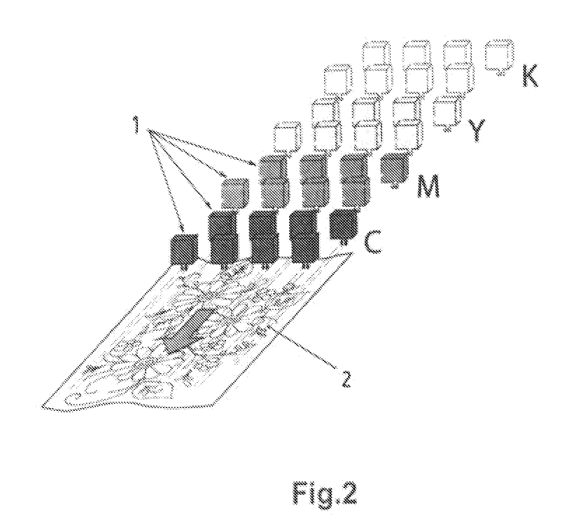

The object of the invention relates to a system for ink-jet printing, essentially for being applied in continuous printing, such as that of FIG. 2, in which the basic colors (C, M, Y, K), i.e., cyan, magenta, yellow and black, are injected by means of groups of individual heads (1) arranged in a staggered manner, thereby covering the width of the surface (2) to be printed, printing being performed with the heads (1) remaining still and longitudinal shifting of the surface (2) under said heads (1); however the application can also be extended to scan printing, such as that of FIG. 1, in which the basic colors (C, M, Y, K) are injected by means of a group of heads (3) which shift together in the transverse direction with respect to the surface (2) to be printed, in successive passes combined with partial shifting of the surface (2) in the longitudinal direction.

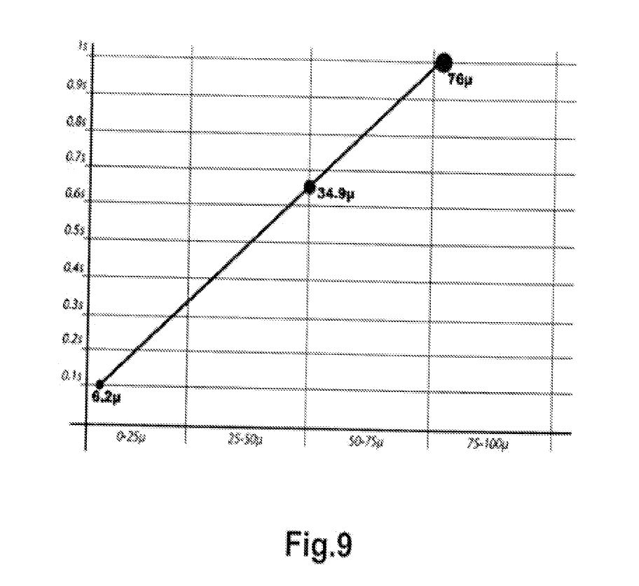

As can be seen in FIG. 9, each ink droplet applied in printing processes progressively increases in size according to the time that elapses from projection until the ink dries, which gives rise to said ink droplets scattering on the printing surface, making the colors look faded to the detriment of quality of the prints.

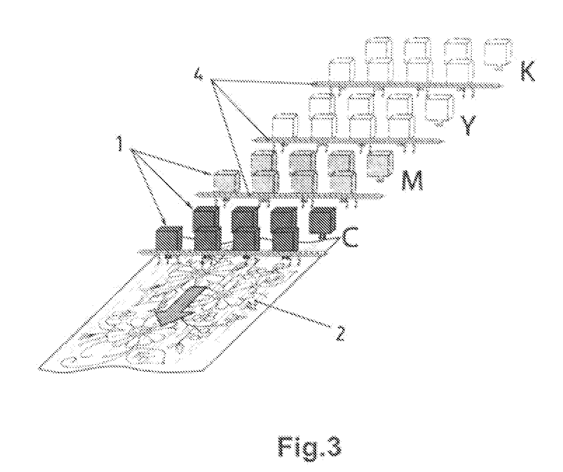

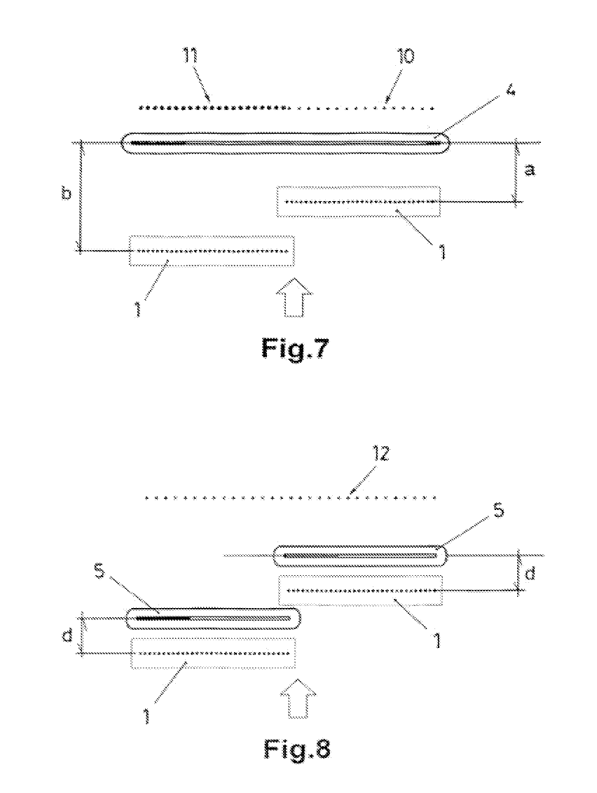

In order to prevent ink scattering on the surface (2) being printed on, the incorporation of drying means (4) between the application of the different basic colors (C, M, Y, K) in continuous printing, as can be seen in FIG. 3, is known. However, as shown in FIG. 7, with this solution inks that are applied by a head (1) of a first group of heads (1) and by another head (1) of a second group of heads (1) arranged in a staggered manner with respect to the first group, are dried by the drying means (4), the first at a distance (a) from the application projection and the second at a distance (b) from the application projection, so the scattering of the first ink droplets (10) and of the second ink droplets (11) is different, said droplets (10) and (11) of both inks ultimately having different sizes in the print on the surface (2) being printed on, so there are different color contrasts in the printing bands corresponding to the heads (1) of the first group and those corresponding to the heads (1) of the second group.

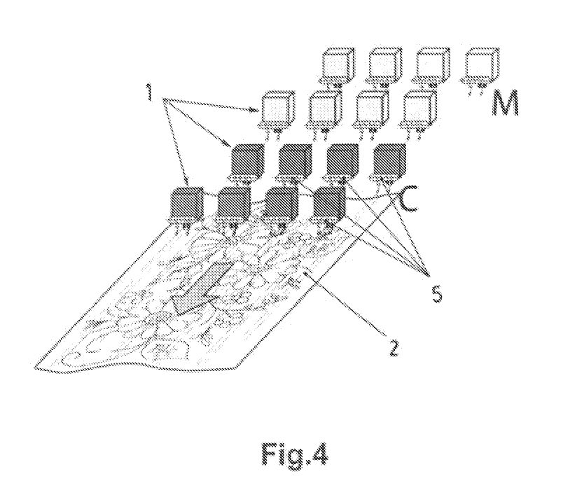

Said problem is solved with the system object of the invention, in which, as seen in FIG. 4, drying means (5) are arranged individually in relation to each of the injection heads (1), each drying means (5) being located next to the respective injection head (1) and with all the drying means (5) being located at one and the same distance with respect to the corresponding injection heads (1), such that the injection of each ink and the drying thereof occur virtually at the same time.

With this arrangement, all the inks projected by the different heads (1), i.e., both inks of the same color and inks of different colors, are dried the same because all the inks dry virtually at the time they are applied, in a single step, and in all cases at one and the same distance (d) from the respective injection heads (1), all the ink droplets (12) ultimately having the same size, as can be seen in FIG. 8, such that perfect color uniformity and maximum homogeneity in the mixture of such colors are obtained by means of controlling the size of said ink droplets (12), since the expansion of ink droplets (12) is prevented.

The drying means (5) that are used for drying the inks in relation to each injection head (1) are means that are chosen such that they do not dry the inks completely because this can cause an effect of rejection of the ink that is injected on another previously applied ink, so it is necessary to perform only a partial drying of the inks to a gelled state.

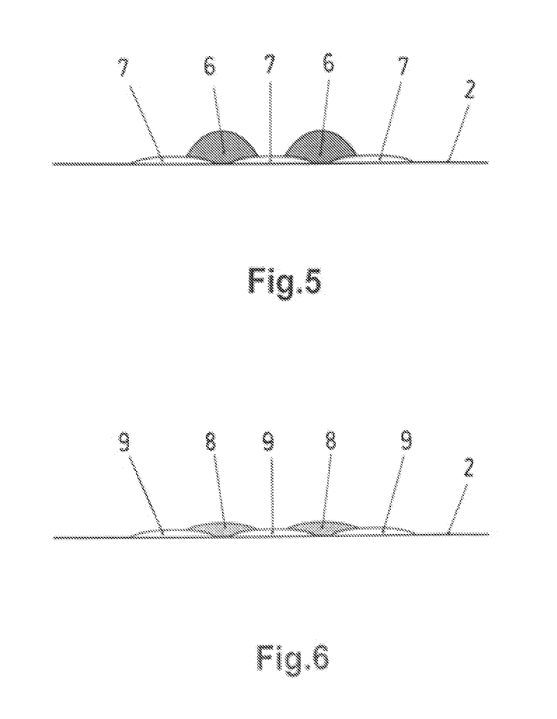

FIG. 5 schematically shows the result of the application of one ink (6) on another previously applied and completely dry ink (7), in which the ink (6) that is applied on top is not absorbed by the dry ink (7) from the previous application, resulting in a faulty print.

FIG. 6 shows the result of applying one ink (8) on another previously applied and only partially dried ink (9), in which the ink (8) that is applied on top is absorbed by the partially dry ink (9) from the previous application, resulting in a uniform print.

The application of the system for printing according to the invention is envisaged with the use of a set of ultraviolet UV-light curable injection inks, using at least one cyan injection ink (C), one magenta injection ink (M), one yellow injection ink (Y) and one black injection ink (K), each of them with a corresponding UV-LED partial drying lamp, obtaining a four-color image made up of the four basic colors (C, M, Y, K) in subtractive mode.

For the partial and individual drying of ultraviolet UV-light curable inks, a good result has been obtained with UV-LED lamps with a rated power of 2 w/cm and a wavelength of about 300 nm. Partial drying of the inks to a gelled state is thereby achieved, which allows making prints without the occurrence of the effect of rejection of the inks that are deposited on other previously applied inks. In this sense, it has been found through experiments that even rated powers of 7 w/cm, in the 300 nm wavelength range, are insufficient for completely drying ultraviolet drying inks with mercury lamps, the rated power range of which is in the order of 120 w/cm, with a wavelength in the order of 500 nm.

The described system for printing corresponding to the object of the invention is susceptible to also being used with basic color inks (C, M, Y, K) for injection printing and enhancement with additional inks, for example white inks, increasing the resulting range of colors.

1. A system for ink-jet printing with drying, comprising the arrangement of a plurality of ink-injection heads by means of which the different basic color ink-jet printing inks are successively projected, in order to form the prints on the application surface, wherein an individual drying means using ultraviolet UV-light energy with LED technology is arranged in relation to each ink-injection head, in an identical location of each drying means next to the corresponding ink-injection head and with an equal distance between each drying means and its respective ink-injection head.

2. The system for ink-jet printing with drying according to claim 1, wherein the drying means are drying means that perform only partial drying of the inks that are projected by the respective ink-injection heads.

3. The system for ink-jet printing with drying according to claim 1, wherein the drying means are UV-LED lamps with a rated power in the order of 2-7 w/cm and a wavelength in the order of 300 nm.

4. The system for ink-jet printing with drying according to claim 1, wherein printing is done using a set of ultraviolet UV-light curable injection inks, using at least one cyan injection ink (C), one magenta injection ink (M), one yellow injection ink (Y) and one black injection ink (K), each of them with a corresponding UV-LED drying lamp.
